(19) United States
(12) Patent Application Publication
(10) Pub. No.: US 2023/0196101 A1
(43) Pub. Date: Jun. 22, 2023

(54) DETERMINING SUITABILITY OF MACHINE LEARNING MODELS FOR DATASETS

(71) Applicant: DataRobot, Inc., Boston, MA (US)

(72) Inventors: Sindhu Ghanta, San Mateo, CA (US); Drew Roselli, Woodinville, WA (US); Nisha Talagala, Saratoga, CA (US); Vinay Sridhar, San Jose, CA (US); Swaminathan Sundararaman, San Jose, CA (US); Lior Amar, Sunnyvale, CA (US); Lior Khermosh, Palo Alto, CA (US); Bharath Ramsundar, Fremont, CA (US); Sriram Subramanian, Dallas, TX (US)

(73) Assignee: DataRobot, Inc., Boston, MA (US)

(21) Appl. No.: 17/988,725

(22) Filed: Nov. 16, 2022

Related U.S. Application Data
(63) Continuation of application No. 16/049,647, filed on Jul. 30, 2018, now abandoned.

(51) Int. Cl. G06N 3/08; G06N 20/00; G06F 17/18; G06N 5/04; G06F 18/21

(52) U.S. Cl. CPC G06N 3/08; G06N 20/00; G06F 17/18; G06N 5/04; G06F 18/217

(57) ABSTRACT

An automated machine learning (“ML”) method may include training a first machine learning model using a first machine learning algorithm and a training data set; validating the first machine learning model using a validation data set, wherein validating the first machine learning model comprises generating an error data set; training a second machine learning model to predict a suitability of the first machine learning model for analyzing an inference data set, wherein the second machine learning model is trained using a second machine learning algorithm and the error data set; and triggering a remedial action associated with the first or second machine learning model in response to a predicted suitability of the first machine learning model for analyzing the inference data set not satisfying a suitability threshold.

### CROSS-REFERENCE TO RELATED PATENT APPLICATIONS

This application claims the benefit of priority under 35 U.S.C. § 120 as a continuation of U.S. patent application Ser. No. 16/049,647, filed Jul. 30, 2018, the contents of such application being hereby incorporated by reference in its entirety and for all purposes as if completely and fully set forth herein.

### FIELD

This disclosure generally relates to automated machine learning and more particularly relates to using a machine learning model to determine (e.g., infer) the suitability of another machine learning model for analyzing an inference data set.

### INTRODUCTION

“Machine learning” (“ML”) generally refers to the application of certain techniques (e.g., pattern recognition and/or statistical inference techniques) by computer systems to perform specific tasks. Machine learning systems may build predictive models based on sample data (e.g., “training data”) and may validate the models using validation data (e.g., “testing data”). The sample and validation data may be organized as sets of records (e.g., “observations”), with each record indicating values for a set of fields. The predictive model may be configured to predict the values of specified data fields (e.g., “dependent variables,” “outputs,” or “targets”) based on the values of other data fields (e.g., “independent variables,” “inputs,” or “features”). When presented with other data (e.g., “inference data”) similar to or related to the sample data, the machine learning system may use such a predictive model to accurately predict the unknown values of the targets of the inference data set.

After a predictive problem is identified, the process of using machine learning to build a predictive model that accurately solves the prediction problem generally includes steps of data collection, data cleaning, feature engineering, model generation, and model deployment. “Automated machine learning” (“AutoML”) techniques may be used to automate steps of the machine learning process or portions thereof.

Machine learning is being integrated into a wide range of use cases and industries. Unlike many other types of applications, machine learning applications (including ML applications involving deep learning and advanced analytics) generally have multiple independent running components that must operate cohesively to deliver accurate and relevant results. Furthermore, slight changes to input data can cause non-linear changes in the results. This complexity can make it difficult to manage or monitor all the interdependent aspects of a machine learning system.

### SUMMARY

In systems that use machine learning models to make predictions and take action based on those predictions, there is a risk that the predictions may ultimately be incorrect and therefore that the actions taken based on those predictions may be regrettable (e.g., harmful, costly, inefficient, etc.). In many such systems, there is a significant delay between the time T1 when the ML model's prediction P is available and actions responsive to that prediction are taken and the time T2 when the accuracy of the prediction P can be conclusively confirmed or rejected. Thus, there is a need for techniques for more quickly determining whether an ML model's prediction is accurate.

The inventors have recognized and appreciated that the problem of predicting whether a machine learning model ML1 is suitable for analyzing an inference data set (e.g., the problem of predicting whether ML1 will produce an accurate prediction for a particular sample of the inference data set) is often simpler (e.g., easier to solve) than the problem of analyzing the inference data set, because the suitability of a model is essentially a binary question, whereas the prediction generated by the model ML1 may be much more complex. Thus, in many cases it is possible to train a second model ML2 to quickly and accurately infer whether the model ML1 is suitable for analyzing an inference data set (e.g., whether the model ML1 is likely to produce an accurate prediction for a particular sample of the inference data set), such that the suitability of the model ML1 can be inferred long before the accuracy of the model ML1 is conclusively confirmed or rejected.

In general, one innovative aspect of the subject matter described in this specification can be embodied in an apparatus including: a primary training module configured to train a first machine learning model using a first machine learning algorithm and a training data set; a primary validation module configured to validate the first machine learning model using a validation data set, wherein validating the first machine learning model includes generating an error data set; a secondary training module configured to train a second machine learning model to predict a suitability of the first machine learning model for analyzing an inference data set, wherein the secondary training module is configured to train the second machine learning model using a second machine learning algorithm and the error data set; and an action module configured to trigger a remedial action associated with the first or second machine learning model in response to a predicted suitability of the first machine learning model for analyzing the inference data set not satisfying a suitability threshold.

Other embodiments of this aspect include corresponding computer systems, computer-implemented methods, and computer programs recorded on one or more computer storage devices, each configured to perform the actions of the apparatus. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the apparatus further includes a secondary validation module configured to determine a suitability of the second machine learning model for predicting the suitability of the first machine learning model. In some embodiments, the secondary validation module uses a confusion matrix and/or one or more training statistics to determine the suitability of the second machine learning model for predicting the suitability of the first machine learning model. In some embodiments, the secondary training module is further configured to train a plurality of different third machine learning models to predict the suitability of the first machine learning model for analyzing the inference data set, and to generate an ensemble of two or more of the third machine learning models, wherein the second machine learning model is the ensemble model.

In some embodiments, the second machine learning model is configured to predict the suitability of the first machine learning model for analyzing an inference data set by generating one or more health values indicating an accuracy with which the first machine learning model generates predictions for the inference data set, in real time, and the action module is configured to trigger the remedial action, in real time and based on the second machine learning model generating the one or more health values. In some embodiments, the one or more health values include one or more prediction confidence values, data deviation values, AB testing values, and/or canary values.

In some embodiments, the remedial action includes retraining the first machine learning model using the first machine learning algorithm and a different training data set. In some embodiments, the remedial action includes replacing the first machine learning model with a different machine learning model trained using different training data. In some embodiments, the remedial action includes recommending one or more different machine learning algorithms for analyzing the inference data set. In some embodiments, the remedial action includes updating one or more thresholds associated with determining the suitability of the first machine learning model for analyzing the inference data set.

In some embodiments, the error data set includes error labels indicating whether the respective predictions of the first machine learning model on the validation data set are accurate; and features of one or more samples of the validation data set, statistical signature scores of one or more samples of the validation data set, prediction values generated by the first machine learning model for one or more samples of the validation data set, confidence metrics associated with the prediction values of the first machine learning model, and/or one or more parameters specific to the first machine learning model.

In some embodiments, the training data set includes continuous labels, and the error labels indicating whether the respective predictions of the first machine learning model are accurate are determined based on a regression algorithm that determines a distance of a predicted value from a true label. In some embodiments, a threshold distance is determined by generating a regression error characteristic (“REC”) curve for the validation data set using the first machine learning algorithm.

In general, another innovative aspect of the subject matter described in this specification can be embodied in a method including: training a first machine learning model using a first machine learning algorithm and a training data set; validating the first machine learning model using a validation data set, wherein validating the first machine learning model includes generating an error data set; training a second machine learning model to predict a suitability of the first machine learning model for analyzing an inference data set, wherein the second machine learning model is trained using a second machine learning algorithm and the error data set; and triggering a remedial action associated with the first or second machine learning model in response to a predicted suitability of the first machine learning model for analyzing the inference data set not satisfying a suitability threshold.

Other embodiments of this aspect include corresponding computer systems, apparatus, and computer programs recorded on one or more computer storage devices, each configured to perform the actions of the method. A system of one or more computers can be configured to perform particular actions by virtue of having software, firmware, hardware, or a combination of them installed on the system (e.g., instructions stored in one or more storage devices) that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. In some embodiments, the actions further include determining a suitability of the second machine learning model for predicting the suitability of the first machine learning model using a confusion matrix and/or one or more training statistics. In some embodiments, the actions further include training a plurality of different third machine learning models to predict the suitability of the first machine learning model for analyzing the inference data set and to generate an ensemble of two or more of the third machine learning models, wherein the second machine learning model is the ensemble model.

In some embodiments, predicting the suitability of the first machine learning model for analyzing an inference data set includes generating one or more health values indicating an accuracy with which the first machine learning model generates predictions for the inference data set, in real time, and the remedial action is triggered in real time and based on the second machine learning module generating the one or more health values.

In some embodiments, the remedial action includes retraining the first machine learning model using the first machine learning algorithm and a different training data set; replacing the first machine learning model with a different machine learning model trained on different training data using the first machine learning algorithm; recommending one or more different machine learning algorithms for analyzing the inference data set; and/or updating one or more thresholds associated with determining the suitability of the first machine learning model for analyzing the inference data set.

In some embodiments, the error data set includes error labels indicating whether the respective predictions of the first machine learning model on the validation data set are accurate; and features of one or more samples of the validation data set, statistical signature scores of one or more samples of the validation data set, prediction values generated by the first machine learning model for one or more samples of the validation data set, confidence metrics associated with the prediction values of the first machine learning model, and/or one or more parameters specific to the first machine learning model.

In general, another innovative aspect of the subject matter described in this specification can be embodied in an apparatus including a primary training module configured to train a first machine learning model using a first machine learning algorithm and a training data set; a primary validation module configured to validate the first machine learning model using a validation data set, wherein validating the first machine learning model includes generating an error data set; means for training a second machine learning model, using a second machine learning algorithm and the error data set, to predict a suitability of the first machine learning model for analyzing an inference data set; and an action module configured to trigger a remedial action associated with the first or second machine learning model in response to a predicted suitability of the first machine learning model for analyzing the inference data set not satisfying a suitability threshold.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

In order that the advantages of the invention will be readily understood, a more particular description of some embodiments will be rendered by reference to specific embodiments that are illustrated in the appended drawings. Understanding that these drawings depict only some embodiments and are not therefore to be considered to be limiting of its scope, some embodiments will be described and explained with additional specificity and detail through the use of the accompanying drawings, in which:

FIG. 1 is a schematic block diagram illustrating a system for determining suitability of machine learning models for datasets, according to some embodiments;

FIG. 2A is a schematic block diagram illustrating a logical machine learning layer for determining suitability of machine learning models for datasets; according to some embodiments;

FIG. 2B is a schematic block diagram illustrating another logical machine learning layer for determining suitability of machine learning models for datasets, according to some embodiments;

FIG. 2C is a schematic block diagram illustrating another logical machine learning layer for determining suitability of machine learning models for datasets, according to some embodiments;

FIG. 3 is a schematic block diagram illustrating an apparatus for determining suitability of machine learning models for datasets, according to some embodiments;

FIG. 4 is a schematic flow chart diagram illustrating a method for determining suitability of machine learning models for datasets, according to some embodiments; and

FIG. 5 is a schematic flow chart diagram illustrating another method for determining suitability of machine learning models for datasets, according to some embodiments.

### DETAILED DESCRIPTION

As used herein, the phrase “machine learning model” may refer to any suitable model artifact generated by the process of training a machine learning algorithm on specific training data. One of ordinary skill in the art will understand that the phrase “the suitability of a machine learning model” may refer to the suitability of the model artifact and/or to the suitability of algorithm used by the model artifact to make predictions on inference data.

Reference throughout this specification to “one embodiment,” “an embodiment,” “some embodiments,” or similar language means that a particular feature, structure, or characteristic described in connection with the embodiment is included in at least one embodiment. Thus, appearances of the phrases “in one embodiment,” “in an embodiment,” “in some embodiments,” and similar language throughout this specification may, but do not necessarily, all refer to the same embodiment, but mean “one or more but not all embodiments” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the subject matter described herein may be embodied as a system, method, and/or computer program product. Accordingly, aspects of some embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of some embodiments may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

The computer program product may include a computer readable storage medium (or media) having computer readable program instructions thereon for causing a processor to carry out aspects of some embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A “non-transitory” computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of some embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of some embodiments.

Aspects of some embodiments are described herein with reference to flowchart illustrations and/or block diagrams of methods, apparatus (systems), and computer program products according to some embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. Some arrows or other connectors may be used to indicate the flow of data. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

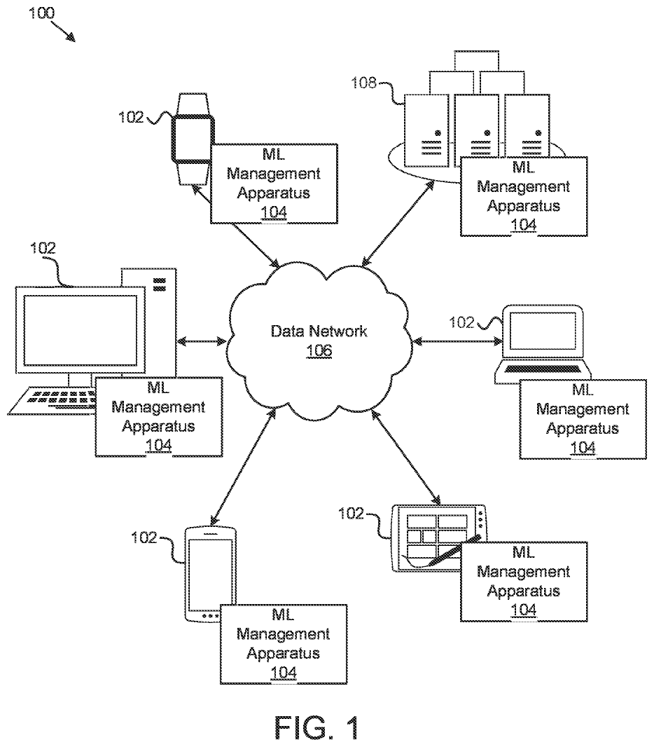

FIG. 1 is a schematic block diagram illustrating one embodiment of a system 100 for determining suitability of machine learning models for datasets. In one embodiment, the system 100 includes one or more information handling devices 102, one or more ML management apparatuses 104, one or more data networks 106, and one or more servers 108. In certain embodiments, even though a specific number of information handling devices 102, ML management apparatuses 104, data networks 106, and servers 108 are depicted in FIG. 1, one of skill in the art will recognize, in light of this disclosure, that any number of information handling devices 102, ML management apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like. The information handling devices 102 may include executable code, functions, instructions, operating systems, and/or the like for performing various machine learning operations, as described in more detail below.

In one embodiment, the ML management apparatus 104 is configured to manage, monitor, maintain, and/or the like the “health” of a machine learning system. As used herein, the “health” of a machine learning system may refer to the suitability (e.g., validity, predictive performance, etc.) of a machine learning model, that is trained on a training data set, for analyzing an inference data set that is processed using the machine learning model (e.g., the capability of the first machine learning model to generate accurate predictions for an inference data set) based on an analysis of the machine learning model using a secondary or auxiliary machine learning model.

As explained in more detail below, a machine learning system may involve various components, pipelines, data sets, and/or the like—such as training pipelines, orchestration/management pipelines, inference pipelines, and/or the like. Furthermore, components may be specially designed or configured to handle specific objectives, problems, and/or the like. In some machine learning systems, a user may determine which machine learning components are to be used to analyze a particular problem/objective, and then manually determine the inputs/outputs for each of the components, the limitations of each component, events generated by each component, and/or the like. Furthermore, with some machine learning systems, it may be difficult to track down where an error occurred, what caused an error, why the predicted results weren't as accurate as they should be, whether the machine learning model is suitable for a particular inference data set, and/or the like, due to the numerous components and interactions within the system.

In one embodiment, the ML management apparatus 104 provides an improvement for machine learning systems by training a first or primary machine learning model using a first/primary machine learning algorithm and a training data set, validating the first machine learning model using a validation data set, wherein validating the first machine learning model includes generating an error data set that may describe the accuracy of the first machine learning model on the validation data set, and training a second machine learning model to predict the suitability of the first ML model for analyzing an inference data set, wherein the second ML model is trained using the error data set. In some embodiments, the second ML model is trained using a second/auxiliary machine learning algorithm. The second machine learning model is then used to determine (e.g., predict, verify, validate, check, monitor, and/or the like) the suitability (e.g., efficacy, accuracy, reliability, and/or the like) of the first or primary machine learning model for analyzing an inference data set.

If the second machine learning model, for example, predicts that the first machine learning model is unsuitable (e.g., not a good fit) for the inference data set, as indicated by one or more suitability scores (or “health scores”), then the ML management apparatus 104 may take one or more actions (e.g., steps, functions, and/or the like) to correct or improve the first machine learning model. For instance, if the suitability score satisfies an unsuitability threshold, indicating that the second ML model predicts that the first machine learning model is not suitable for the inference training data, the ML management apparatus 104 may change the first machine learning model, may retrain the first machine learning model, may provide one or more recommendations for generating a machine learning model more accurate than the first machine learning model, may adjust or update various thresholds or parameters of the first machine learning model, and/or the like. On the other hand, if the suitability score satisfies an unsuitability threshold but the ML management apparatus subsequently determines that the first ML model is, in fact, suitable for the inference training data, the ML management apparatus 104 may change or retrain the second machine learning model, may provide one or more recommendations for generating a machine learning model more accurate than the second machine learning model, may adjust or update various thresholds or parameters associated with the second machine learning model (e.g., an unsuitability threshold), and/or the like.

Furthermore, the ML management apparatus 104 may determine the suitability of a first machine learning model for analyzing an inference data set using a second machine learning model at any point in the machine learning system 100. For example, if the machine learning system 100 is a deep learning system that includes multiple inference layers, the ML management apparatus 104 may determine how suitable the first machine learning model is for the inference data set by evaluating the suitability of the first machine learning model using the second machine learning model at any layer (e.g., each layer) of the deep learning system.

In the life cycle of a machine learning model, there is a training phase for generating the machine learning model and an inference phase for analyzing an inference data set using the machine learning model. The output from the inference phase may include one or more predictive values (e.g., “labels”) determined based on (e.g., as a function of) one or more features of the inference data set. For example, if the training data set comprises three columns of feature data—Age, Sex, and Height—that are used to train the machine learning model, and the inference data comprises two columns of feature data—Age and Height—the output from an inference pipeline 206 using the machine learning model may be a “label” describing the predicted Sex (Male/Female) based on the given inference data.

In the training phase, the predictive outputs generated by the ML model for a data set may be compared to reference values for that data set to determine the suitability of the machine learning model, e.g., the accuracy or predictive performance of the machine learning model. In this way, the predictive performance of the ML model may be evaluated on either the training data set or a separate validation or test set for which both the feature information and reference target information are already available. However, the use of reference target information to assess the suitability of a ML model generally does not allow for determining or estimating the predictive performance of the machine learning model in real-time during or prior to the inference phase, because the nature of the predictive modeling problem suggests that reference target information is not available a priori. Furthermore, waiting for reference labels to be generated to validate the efficacy of a machine learning model may delay the analysis of the model's efficacy, which can cause business losses or other issues when the predictive performance of the machine learning model deviates or drops during that period of delay.

In contrast, some embodiments of the ML management apparatus 104 evaluate the suitability (e.g., predictive performance) of a first machine learning model and/or the like for an inference data set in the absence of reference labels for the inference data set using a second machine learning model. In some embodiments, the second ML model is agnostic to the type of predictive modeling problem addressed by the first ML model, the type of the first ML model, the type of ML algorithm used to generate the first ML model, the particular language or framework used to generate the first ML model, and/or the like. Related techniques for evaluating the suitability of a ML model by extracting statistics from features in the training data set and the inference data set, and using the statistics to generate a suitability score indicating how applicable the training data set is likely to be to the inference data set, are described in International Application No. PCT/US2019/035853, titled “Detecting Suitability of Machine Learning Models for Datasets” and filed on Jun. 6, 2019 (Docket No. DRB-101 WO), which is hereby incorporated herein by reference to the maximum extent permitted by applicable law.

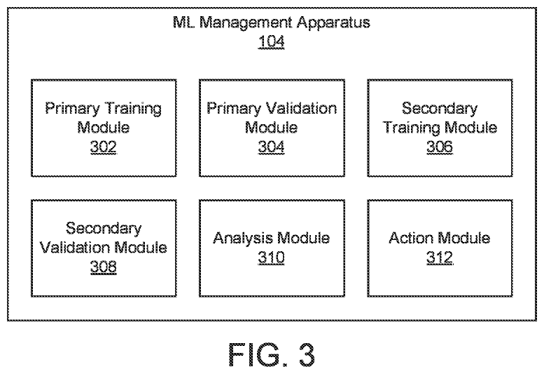

Still referring to FIG. 1, the ML management apparatus 104, including its various sub-modules, may be located on one or more information handling devices 102 in the system 100, one or more servers 108, one or more network devices, and/or the like. Some embodiments of the ML management apparatus 104 are described in more detail below with reference to FIG. 3.

In various embodiments, the ML management apparatus 104 may be embodied as a hardware appliance that can be installed or deployed on an information handling device 102, on a server 108, or elsewhere on the data network 106. In certain embodiments, the ML management apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the ML management apparatus 104 may include a power interface, a wired and/or wireless network interface, a graphical interface that attaches to a display, and/or a semiconductor integrated circuit device as described below, configured to perform the functions described herein with regard to the ML management apparatus 104.

The ML management apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the ML management apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the ML management apparatus 104.

The semiconductor integrated circuit device or other hardware appliance of the ML management apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the ML management apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. Each standard and/or connection type may include the latest version and revision of the standard and/or connection type as of the filing date of this disclosure.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. The one or more servers 108 may store data associated with an information handling device 102, such as machine learning data, algorithms, training models, and/or the like.

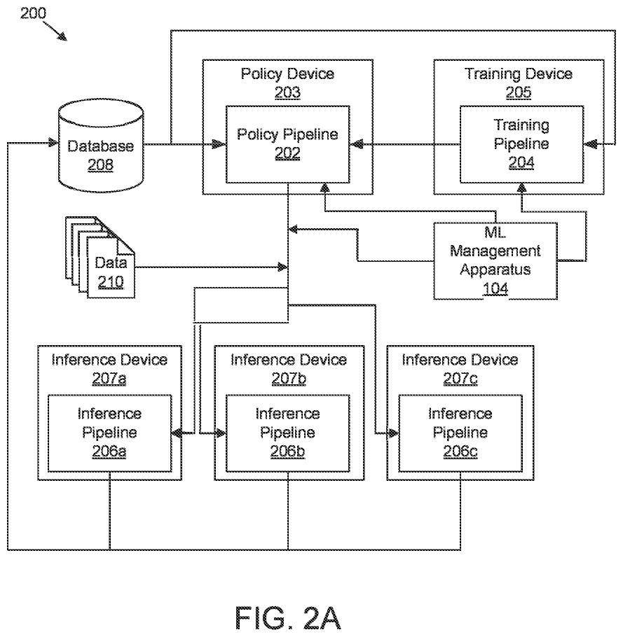

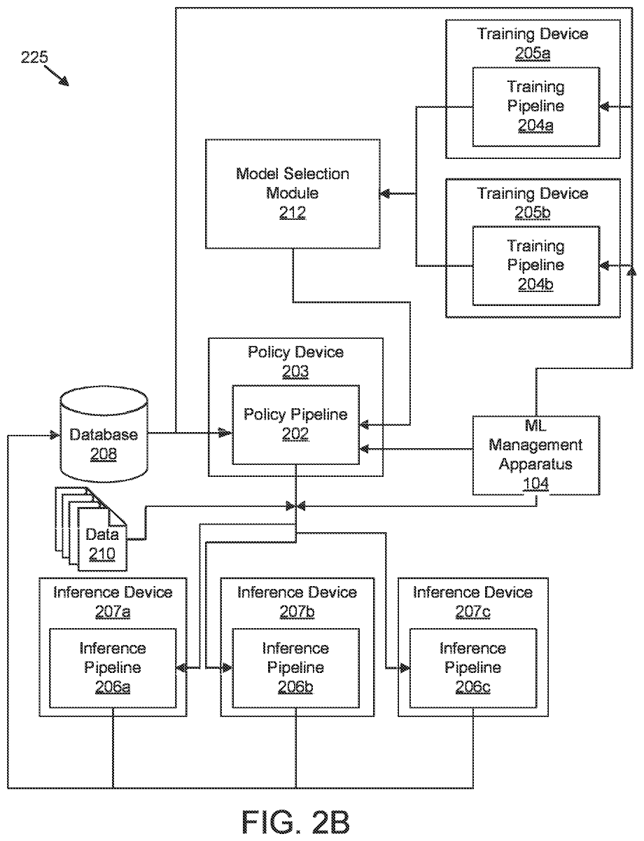

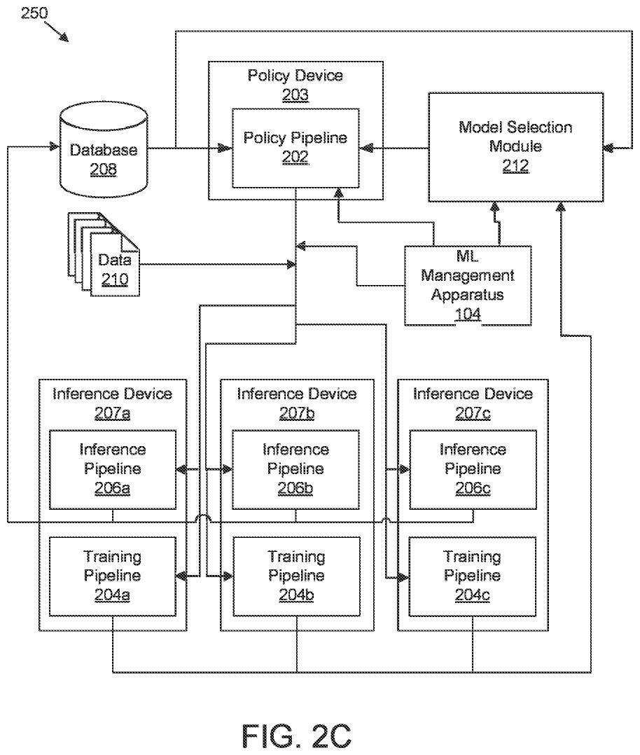

FIG. 2A is a schematic block diagram illustrating one embodiment of a machine learning layer 200 for determining suitability of machine learning models for datasets. In one embodiment, the logical machine learning layer 200 includes one or more policy/control pipelines 202, one or more training pipelines 204, one or more inference pipelines 206a-c, one or more databases 208, input data 210, and an ML management apparatus 104. Even though a specific number of machine learning pipelines 202, 204, 206a-c are depicted in FIG. 2A, one of skill in the art, in light of this disclosure, will recognize that any number of machine learning pipelines 202, 204, 206a-c may be present in the logical machine learning layer 200. Furthermore, as depicted in FIG. 2A, the various pipelines 202, 204, 206a-c may be located on different nodes embodied as devices 203, 205, 207a-c such as information handling devices 102 described above, virtual machines, cloud or other remote devices, and/or the like. In some embodiments, the machine learning layer 200 is an embodiment of a logical machine learning layer, also known as an intelligence overlay network (“ION”).

As used herein, machine learning pipelines 202, 204, 206a-c may comprise various machine learning features, components, objects, modules, and/or the like, which the pipelines may use to perform various machine learning operations such as model training/inference, feature engineering, validation, scoring, and/or the like. Pipelines 202, 204, 206a-c may analyze or process data 210 in batch, e.g., process all the data at once from a static source, via streaming, e.g., operate incrementally on live data, or a combination of the foregoing, e.g., a micro-batch.

In certain embodiments, each pipeline 202, 204, 206a-c executes on a device 203, 205, 207a-c, e.g., an information handling device 102, a virtual machine, and/or the like. In some embodiments, multiple different pipelines 202, 204, 206a-c execute on the same device. In various embodiments, each pipeline 202, 204, 206a-c executes on a distinct or separate device. The devices 203, 205, 207a-c may all be located at a single location, may be connected to the same network, may be located in the cloud or another remote location, and/or some combination of the foregoing.

In one embodiment, each pipeline 202, 204, 206a-c is associated with an analytic engine and executes on a specific analytic engine type for which the pipeline is 202, 204, 206a-c configured. As used herein, an analytic engine comprises the instructions, code, functions, libraries, and/or the like for performing machine learning numeric computation and analysis. Examples of analytic engines may include Spark, Flink, TensorFlow, Caffe, Theano, and PyTorch. Pipelines 202, 204, 206a-c developed for these engines may contain components provided in modules/libraries for the particular analytic engine (e.g., Spark-ML/MLlib for Spark, Flink-ML for Flink, and/or the like). Custom programs may also be included that are developed for each analytic engine using the application programming interface for the analytic engine (e.g., DataSet/DataStream for Flink). Furthermore, each pipeline may be implemented using various different platforms, libraries, programming languages, and/or the like. For instance, an inference pipeline 206a may be implemented using Python, while a different inference pipeline 206b is implemented using Java.

In one embodiment, the machine learning layer 200 includes physical and/or logical groupings of the machine learning pipelines 202, 204, 206a-c based on a desired objective, result, problem, and/or the like. For instance, the ML management apparatus 104 may select a training pipeline 204 for generating a machine learning model configured for the desired objective and one or more inference pipelines 206a-c that are configured to analyze the desired objective by processing input data 210 associated with the desired objective using the analytic engines for which the selected inference pipelines 206a-c are configured and the machine learning model. Thus, groups may comprise multiple analytic engines, and analytic engines may be part of multiple groups. Groups can be defined to perform different tasks such as analyzing data for an objective, managing the operation of other groups, monitoring the results/performance of other groups, experimenting with different machine learning algorithms/models in a controlled environment, e.g., sandboxing, and/or the like.

For example, a logical grouping of machine learning pipelines 202, 204, 206a-c may be constructed to analyze the results, performance, operation, health, and/or the like of a different logical grouping of machine learning pipelines 202, 204, 206a-c by processing feedback, results, messages, and/or the like from the monitored logical grouping of machine learning pipelines 202, 204, 206a-c and/or by providing inputs into the monitored logical grouping of machine learning pipelines 202, 204, 206a-c to detect anomalies, errors, and/or the like.

Because the machine learning pipelines 202, 204, 206a-c may be located on different devices 203, 205, 207a-c, the same devices 203, 205, 207a-c, and/or the like, the ML management apparatus 104 logically groups machine learning pipelines 202, 204, 206a-c that are best configured for analyzing the objective. As described in more detail below, the logical grouping may be predefined such that a logical group of machine learning pipelines 202, 204, 206a-c may be particularly configured for a specific objective.

In certain embodiments, the ML management apparatus 104 dynamically selects machine learning pipelines 202, 204, 206a-c for an objective when the objective is determined, received, and/or the like based on the characteristics, settings, and/or the like of the machine learning pipelines 202, 204, 206a-c. In certain embodiments, the multiple different logical groupings of pipelines 202, 204, 206a-c may share the same physical infrastructure, platforms, devices, virtual machines, and/or the like. Furthermore, the different logical groupings of pipelines 202, 204, 206a-c may be merged, combined, and/or the like based on the objective being analyzed.

In one embodiment, the policy pipeline 202 is configured to maintain/manage the operations within the logical machine learning layer 200. In certain embodiments, for instance, the policy pipeline 202 receives machine learning models from the training pipeline 204 and pushes the machine learning models to the inference pipelines 206a-c for use in analyzing the input data 210 for the objective. In various embodiments, the policy pipeline 202 receives user input associated with the logical machine learning layer 200, receives event and/or feedback information from the other pipelines 204, 206a-c, validates machine learning models, facilitates data transmissions between the pipelines 202, 204, 206a-c, and/or the like.

In one embodiment, the policy pipeline 202 comprises one or more policies that define how pipelines 204, 206a-c interact with one another. For example, the training pipeline 204 may output a machine learning model after a training cycle has completed. Several possible policies may define how the machine learning model is handled. For example, a policy may specify that the machine learning model can be automatically pushed to inference pipelines 206a-c while another policy may specify that user input is required to approve a machine learning model prior to the policy pipeline 202 pushing the machine learning model to the inference pipelines 206a-c. Policies may further define how machine learning models are updated.

For instance, a policy may specify that a machine learning model be updated automatically based on feedback, e.g., based on machine learning results received from an inference pipeline 206a-c; a policy may specify whether a user is required to review, verify, and/or validate a machine learning model before it is propagated to inference pipelines 206a-c; a policy may specify scheduling information within the logical machine learning layer 200 such as how often a machine learning model is updated (e.g., once a day, once an hour, continuously, and/or the like); and/or the like.

Policies may define how different logical groups of pipelines 202, 204, 206a-c interact or cooperate to form a cohesive data intelligence workflow. For instance, a policy may specify that the results generated by one logical machine learning layer 200 be used as input into a different logical machine learning layer 200, e.g., as training data for a machine learning model, as input data 210 to an inference pipeline 206a-c, and/or the like. Policies may define how and when machine learning models are updated, how individual pipelines 202, 204, 206a-c communicate and interact, and/or the like.

In one embodiment, the policy pipeline 202 maintains a mapping of the pipelines 204, 206a-c that comprise the logical grouping of pipelines 204, 206a-c. The policy pipeline may further adjust various settings or features of the pipelines 204, 206a-c in response to user input, feedback or events generated by the pipelines 204, 206a-c, and/or the like. For example, if an inference pipeline 206a generates machine learning results that are inaccurate, the policy pipeline 202 may receive a message from the inference pipeline 202 that indicates the results are inaccurate, and may direct the training pipeline 204 to generate a new machine learning model for the inference pipeline 206a.

The training pipeline 204, in one embodiment, is configured to generate a machine learning model for the objective that is being analyzed based on historical or training data associated with the objective. As used herein, a machine learning model is generated by executing a training or learning algorithm on historical or training data associated with a particular objective. The machine learning model is an artifact that is generated by the training process, which captures patterns within the training data that map the input data to the target, e.g., the desired result/prediction. In one embodiment, the training data may be a static data set, data accessible from an online source, a streaming data set, and/or the like.

The inference pipelines 206a-c, in one embodiment, use the generated machine learning model and the corresponding analytics engine to generate machine learning results/predictions on input/inference data 210 associated with the objective. The input data may comprise data which are associated with the objective that is being analyzed, but were not part of the training data, e.g., the patterns/outcomes of the input data are not known. For example, if a user wants to know whether an email is spam, the training pipeline 204 may generate a machine learning model using a training data set that includes both emails that are known to be spam and emails that are known to not be spam. After the machine learning model is generated, the policy pipeline 202 pushes the machine learning model to the inference pipelines 206a-c, where it is used to predict whether one or more emails, e.g., provided as input/inference data 210, are spam.

Thus, as depicted in FIG. 2A, a policy pipeline 202, a training pipeline 204 and inference pipelines 206a-c are depicted in an edge/center graph. In the depicted embodiment, new machine learning models are periodically trained in a batch training pipeline 204, which may execute on a large clustered analytic engine in a data center. As the training pipeline 204 generates new machine learning models, an administrator may be notified. The administrator may review the generated machine learning models, and if the administrator approves, the machine learning models are pushed to the inference pipelines 206a-c that comprise the logical pipeline grouping for the objective, each of which may be executing on live data coming from an edge device, e.g., input/inference data 210.

FIG. 2B is a schematic block diagram illustrating another embodiment of a logical machine learning layer 225 for determining suitability of machine learning models for datasets. In one embodiment, the logical machine learning layer 225 of FIG. 2B is substantially similar to the logical machine learning layer 200 depicted in FIG. 2A. In addition to the elements of the logical machine learning layer 200 depicted in FIG. 2A, the logical machine learning layer 225 of FIG. 2B includes a plurality of training pipelines 204a-b, executing on training devices 205a-b.

In the depicted embodiment, the training pipelines 204a-b generate machine learning models for an objective, based on training data for the objective. The training data may be different for each of the training pipelines 204a-b. For instance, the training data for a first training pipeline 204a may include historical data for a predefined time period while the training data for a second training pipeline 204b may include historical data for a different predefined time period. Variations in training data may include different types of data, data collected at different time periods, different amounts of data, and/or the like.

In other embodiments, the training pipelines 204a-b may execute different training or learning algorithms on different or the same sets of training data. For instance, the first training pipeline 204a may implement a training algorithm TensorFlow using Python, while the second training pipeline 204b implements a different training algorithm in Spark using Java, and/or the like.

In one embodiment, the logical machine learning layer 225 includes a model selection module 212 that is configured to receive the machine learning models that the training pipelines 204a-b generate and determine which of the machine learning models is the best fit for the objective that is being analyzed. The best-fitting machine learning model may be the machine learning model that produced results most similar to the reference results for the training data (e.g., the most accurate machine learning model), the machine learning model that executes the fastest, the machine learning model that requires the least amount of configuration, and/or the like.

In one embodiment, the model selection module 212 performs a hyper-parameter search to generate ML models and determine which of the generated machine learning models is the best fit for the given objective. As used herein, a hyper-parameter search, optimization, or tuning is the problem of choosing a set of optimal hyper-parameters for a learning algorithm. In certain embodiments, the same kind of machine learning model can use different constraints, weights, or learning rates to generalize different data patterns. These measures may be called hyper-parameters, and may be tuned so that the model can optimally solve the machine learning problem. Hyper-parameter optimization finds a set of hyper-parameters that yields an optimal machine learning model that minimizes a predefined loss function on given independent data. In certain embodiments, the model selection module 212 combines different features of the different machine learning models to generate a single combined model. In one embodiment, the model selection module 212 pushes the selected machine learning model to the policy pipeline 202 for propagation to the inference pipelines 206a-c. In various embodiments, the model selection module 212 is part of, communicatively coupled to, operatively coupled to, and/or the like the ML management apparatus 104.

FIG. 2C is a schematic block diagram illustrating a certain embodiment of a logical machine learning layer 250 for determining suitability of machine learning models for datasets. In one embodiment, the logical machine learning layer 250 of FIG. 2C is substantially similar to the logical machine learning layers 200, 225 depicted in FIGS. 2A and 2B, respectively. In further embodiments, FIG. 2C illustrates a federated learning embodiment of the logical machine learning layer 250.

In a federated machine learning layer, in one embodiment, the training pipelines 204a-c are located on the same physical or virtual devices as the corresponding inference pipelines 206a-c. In such an embodiment, the training pipelines 204a-c generate different machine learning models and send the machine learning models to the model selection module 212, which determines which machine learning model is the best fit for the logical machine learning layer 250, as described above, or combines/merges the different machine learning models, and/or the like. The selected machine learning model is pushed to the policy pipeline 202, for validation, verification, or the like, which then pushes it back to the inference pipelines 206a-c.

FIG. 3 is a schematic block diagram illustrating one embodiment of an apparatus 300 for determining suitability of machine learning models for datasets. In one embodiment, the apparatus 300 includes an embodiment of an ML management apparatus 104. The ML management apparatus 104, in one embodiment, includes one or more of a primary training module 302, a primary validation module 304, a secondary training module 306, a secondary validation module 308, an analysis module 310, and an action module 312, which are described in more detail below.

In one embodiment, the primary training module 302 is configured to train a first machine learning model using a first machine learning algorithm and a training data set. In such an embodiment, the first machine learning algorithm may be any one of several available machine learning algorithms such as linear regression, logistic regression, linear discriminant analysis (“LDA”), classification and regression tress, naive bayes, K-nearest neighbors, learning vector quantization, support vector machines, bagging and random forest, boosting, and/or the like. The first machine learning algorithm may be selected based on whether the training data set comprises continuous labels or classification labels, for example. The first machine learning algorithm, in certain embodiments, may comprise an ensemble or combination of various machine learning algorithms.

In one embodiment, the primary training module 302 trains the first machine learning model using the first machine learning algorithm and a training data set. For instance, the primary training module 302 may receive, read, access, and/or the like a training data set and provide the training data set to a training pipeline 204 to train the machine learning model. In such an embodiment, the training data set includes reference labels that allow the first machine learning model to “learn” from the data to perform predictions on an inference data set that does not include reference labels. For example, the training data set may include various data points for dogs such as weight, height, gender, breed, etc. The primary training module 302 may train the machine learning model using the dog training data set so that it can be used to predict various characteristics of the dog such as a dog's weight, gender, breed, and/or the like using an inference data set that does not include labels for the features that are being predicted.

In one embodiment, the primary validation module 304 is configured to validate the first machine learning model using a validation data set. The validation data set, in one embodiment, comprises a data set that includes reference labels for various features so that when the first machine learning model analyzes the validation data set, the predictions that the first machine learning model generates can be compared against the reference labels in the validation data set to determine the accuracy of the predictions.

In some embodiments, the secondary training module 306 is configured to train a second machine learning model using a second machine learning algorithm and an error data set. The error data set may include the output of the validation of the first machine learning model, for example, the predictions generated by the first ML model for one or more (e.g., each) of the observations in the validation data set. The error data set, in certain embodiments, includes values indicating the prediction error of the first machine learning model on the validation data set (e.g., a rate, a score, or other value that indicates how often the first machine learning model accurately predicted a label for the validation data set; the reference output values for one or more (e.g., each) of the observations in the validation data set; labels indicating whether the predictions generated by the first ML model match the reference output values for one or more (e.g., each) of the observations in the validation data set; etc.).

In one embodiment, the error data set includes labels that indicate whether the predictions generated by the first machine learning model for the validation data set satisfy pass/fail criteria for the first machine learning model (such as the term “pass” or “fail,” a 1 or 0 value, and/or real numbers that are indicative of pass/fail status when compared to a predefined threshold). In some embodiments, the error data set includes the feature values of the validation data set, statistical signature scores of one or more (e.g., all) samples in the error data set, prediction values generated by the first machine learning model, confidence metrics associated with predictions of the first machine learning model, and/or one or more parameters specific to the first machine learning model.

For example, a validation data set that includes categorical data may have six classes corresponding to human activity such as walking, standing, sleeping, etc. The features for this dataset may be values collected from a smart device such as a fitness tracker, a smart phone, or the like. The primary training module 302, in one embodiment, trains the first machine learning model on these features and labels using the training data set. The primary validation module 304, in some embodiments, uses a validation data set that includes the same features, but different data, to predict the labels using the first machine learning model. The primary validation module 304 may compare the predictions made by the first ML model to the reference (“true”) labels of the test data to calculate the error rate, suitability score, weight, or other value.

In certain embodiments, in the case of data that include continuous labels (e.g., real numbers), which may be analyzed using a regression or other machine learning algorithm suitable for handling continuous data values, the primary validation module 304 may determine pass/fail criteria for the first machine learning model (note that this task is often trivial for data that includes classification labels because a “fail” may be determined when the prediction of the first machine learning model does not match the reference label of the validation data set).

The predictive performance of a regression model, or the like, may be assessed based on the distance of the predicted value from the reference label. The lower this distance/error is, the more accurate the predictive performance of the first machine learning model may be. A threshold may be set on this error value or on a normalized measure of the error, for example, the ratio of the error value to the reference label (“percentage error”), to determine the pass/fail criterion. When the error metric is lower than this threshold, for example, the label is pass and fail otherwise. These may form the labels for the error data set that the second machine learning algorithm uses for training. The value of this threshold value may be dataset dependent. Furthermore, the threshold parameter may be customizable, e.g., may be set by a user. In one embodiment, the primary validation module 304 calculates a default threshold value that is adapted to the dataset.

For example, the primary validation module 304 may plot the values of the error metric for the predictions of the first ML model on a regression error characteristic (“REC”) curve. The “knee” of the curve may be chosen as the threshold value, which may be determined using the double differential of the REC curve. The point whose neighbors are both greater (in the double differential REC curve) may be chosen, and its corresponding x-axis value may become the default threshold value for the pass/fail criterion.

In one embodiment, the secondary training module 306 is configured to train a second machine learning model using a second machine learning algorithm and an error data set for the first ML model as described herein. The second machine learning model may be configured to predict a suitability of the first machine learning model for analyzing an inference data set. As used herein, the suitability may be represented by a value such as a suitability score (or “health score”) that describes the efficacy, accuracy, effectiveness, or the like of the predictions that the first machine learning model generates for the inference data set.

In one embodiment, the second machine learning algorithm is different than the first machine learning algorithm. For example, if the first machine learning algorithm is a linear regression algorithm, the second machine learning algorithm may comprise a logistic regression algorithm. In certain embodiments, the first and second machine learning algorithms are the same machine learning algorithms. Any second machine learning algorithm that is suitable for assessing the suitability of the first machine learning model for making predictions on an inference data set may be used.

In one embodiment, the secondary training module 306 enhances the error data set by including additional data to supplement the prediction error data. For instance, the secondary training module 306 may include data for additional features such as features of the validation data set itself (e.g., the secondary training module 306 may select all or a subset of the available features of the validation data set itself), statistical signature scores for one or more (e.g., all) samples in the validation data set (e.g., a statistical score that is calculated using statistical algorithms for statistically describing a data set, including but not limited to statistical scores calculated using the techniques described in International Application No. PCT/US2019/035853), prediction values from the first machine learning model (e.g., the predicted values output from analyzing the inference data set using the first machine learning model), confidence metrics associated with the predictions of the first machine learning model, parameters that are specific to the first machine learning model, and/or the like.

In one embodiment, the secondary validation module 308 is configured to determine a suitability of the second machine learning model for predicting the suitability of the first machine learning model. For instance, the secondary validation module 308 may analyze the second machine learning model using a confusion matrix, which may summarize the performance of the second ML model by indicating the number or rate of false positive predictions, false negative predictions, true positive predictions, and true negative predictions generated by the second ML model. In general, a confusion matrix (also known as an error matrix) may be represented in a specific table layout that allows visualization of the performance of a machine learning model. For example, a confusion matrix may be represented a table with two rows and two columns that report the number or rate of false positives (FP), false negatives (FN), true positives (TP), and true negatives (TN) for a machine learning model on a particular data set.

In further embodiments, the secondary validation module 308 analyzes other statistics, such as training statistics, to determine the suitability of the second machine learning model in accurately assessing the suitability (e.g., effectiveness) of the first machine learning model. The other statistics may include confidence metrics, accuracy metrics, precision metrics, and/or the like. The values of these statistics may be compared to threshold values (e.g., predetermined threshold values) to determine whether the statistical metrics indicate that the second machine learning model is suitable or unsuitable. For example, the secondary validation module 308 may verify that the false positive, false negative, true positive, and/or true negative values in the confusion matrix satisfy respective threshold values (e.g., predetermined threshold values). One of skill in the art will recognize, in light of this disclosure, various statistical measures that may be used to assess the suitability of the second machine learning model.

In certain embodiments, the secondary validation module 308 determines the suitability of an ensemble of second machine learning models (e.g., a combination of two or more machine learning models) for predicting the suitability (e.g., performance or accuracy) of the predictions of the first machine learning model for an inference data set. The secondary training module 306, in one embodiment, may generate ensembles that include different combinations of machine learning models to determine which ensemble is the best fit or satisfies a suitability threshold for analyzing the predictive performance of the first machine learning model. In such an embodiment, the secondary training module 306 may be configured to train a plurality of different second machine learning models on different training data, and generate various ensembles of second machine learning models.

In one embodiment, the second machine learning algorithm/model analyzes the predictive performance of the first machine learning model after the first machine learning model analyzes the inference data set so that the predictions that the first machine learning model generates can be used as input into the training of the second machine learning model, along with the error data. In certain embodiments, if the second machine learning model has already been trained, the first and second machine learning models may run substantially simultaneously based on the inference data set to determine the predictive performance of the first machine learning model in real-time, or substantially in real-time. In certain embodiments, the second machine learning model may predict whether the value V generated by the first predictive model for a sample S of an inference data set is correct or incorrect prior to the first predictive model generating the value V and/or without reference to the value V generated by the first predictive model.

The analysis module 310, in one embodiment, is configured to determine whether the first machine learning model is suitable for generating predictions for the inference data set based on the predictions that the second machine learning model generates. For instance, the analysis module 310 may analyze the analytic metrics described herein (e.g., various health scores, error rates, confusion matrix values) and/or the like to generate a suitability value and determine whether the suitability value satisfies a predefined threshold. For example, the analysis module 310 may determine whether the various metrics each satisfy a threshold value, whether a percentage of the metrics satisfy threshold values, or whether a calculated combination of various metrics (e.g., an average) satisfies a threshold. If so, then the analysis module 310 may determine that the first machine learning model is generating accurate predictions for the inference data set.

In some embodiments, the analytic metrics may include prediction confidence values, data deviation values, A/B testing values, canary values, and/or the like. In this context, a “canary value” may be a prediction generated by a third ML model that is known to be suitable (or regarded as being suitable) for analyzing the same inference data set analyzed by the first ML model. If the predictive performance of the first ML model is worse (e.g., significantly worse) than the predictive performance of the canary ML model on an inference data set, this deviation may suggest that the first ML model is unsuitable for analyzing the inference data set. In this context, an “AB testing value” may be a prediction generated by a third ML model that is a candidate to be replaced by the first ML model. If the predictive performance of the first ML model is better (e.g., significantly better) than the predictive performance of the canary ML model on an inference data set, this deviation may suggest that the first ML model is suitable for analyzing the inference data set.

Table 1 below illustrates an example output data set that the analysis module 310 may analyze to determine whether the first machine learning model is a good fit for the inference data set:

TABLE 1
Classification and Logistic Regression.

| | | | | | | Confusion Matrix | |
|---|---|---|---|---|---|---|---|
| | | Secondary model | | | | [TN, FP | |
| | Primary | predicted accuracy | | ML_squared_error | | FN, TP] | |
| | model | | with primary | | with primary | | with primary |
| Dataset | error | | predictions | | predictions | | predictions |
| Samsung | 0.92 | 0.92 | 0.92 | 0.88 | 0.88 | [63. 159.] | [60. 168.] |
| | | | | | | [183. 2542.] | [196. 2523.] |
| Yelp | 0.95 | 0.95 | 0.95 | 0.97 | 0.98 | [73. 21.] | [77. 20.] |
| | | | | | | [28. 1838.] | [23. 1840.] |
| Census | 0.78 | 0.63 | 0.64 | 0.79 | 0.8 | [2032. 1930.] | [2037. 1852.] |
| | | | | | | [360. 6532.] | [355. 6610.] |
| Forest | 0.65 | 0.64 | 0.59 | 0.73 | 0.74 | [42855. 27694.] | [48714. 30977.] |
| | | | | | | [24669. 98453.] | [18451. 95529.] |
| Letter | 0.71 | 0.6 | 0.62 | 0.80 | 0.84 | [1640. 1036.] | [1711. 806.] |
| | | | | | | [323. 3668.] | [276. 3874.1 |

The primary algorithm error column of Table 1, in one embodiment, indicates the prediction error of the first machine learning model in performing the primary task of classification for a given data set. For example, the data set used to generate the data in Table 1 has six classes corresponding to human activity such as walking, standing, etc. The features for this data set may include values collected from a mobile phone. The first machine learning algorithm trains on these features and labels using the training data set to generate the first machine learning model. Later, the first machine learning model is used to predict labels using the features in a validation data set. The primary validation module 304 compares the predictions made by the first machine learning model to the reference (“true”) label of the validation data to calculate primary model error values.

The secondary model predicted accuracy column of Table 1 indicates the accuracy of the first machine learning model as predicted by the second ML model. In one embodiment, the system may determine that the first machine learning model is suitable for an inference data set if the accuracy of the first ML model for the inference data set as predicted by the second ML model is at least equal to, or at least substantially equal to, the value in the “primary model error” column. As explained herein, the second machine learning algorithm receives features of the error data set (which may include features of the inference data set, error data, and/or other features) as input and predicts whether the first machine learning model is suitable for making accurate predictions on the inference data set. In one embodiment, the second machine learning model identifies samples for which the first machine learning algorithm is predicted to be unsuccessful in making correct predictions. The sub-column “with primary predictions” of the column “secondary model predicted accuracy” includes values indicating the accuracy of the first machine learning model as predicted by the second machine learning model when the second ML model uses the values predicted by the primary model as inputs.

The values in the ML_squared_accuracy column of Table 1, in one embodiment, describe the suitability of the second machine learning model in making accurate predictions regarding the predictive performance of the first machine learning model. In one embodiment, the secondary validation module 308 assesses the suitability of the second ML model and generates the values in the ML_squared_accuracy column. Sometimes the aggregate statistics in the columns “primary model error” and “secondary model predicted accuracy” may match, but the individual, per-sample predictions may be incorrect. For example, some 0's may be predicted as 1's and some 1's may be predicted as 0's (where 0 is a fail and 1 is a pass). The ML_squared_accuracy metric may be based on a sample by sample comparison of the actual performance of the first (primary) ML model and the performance of the first (primary) ML model as predicted by the second (secondary) ML model, and therefore may be useful for evaluating the predictive performance of the first machine learning model. The sub-column “with primary predictions” of the “ML_squared_accuracy” column includes values that describe the suitability of the second machine learning model in making accurate predictions regarding the predictive performance of the first machine learning model when the second ML model uses the values predicted by the primary model as inputs.

In one embodiment, the confusion matrix column of Table 1 includes the confusion matrix values that the secondary validation module 308 generates for the second machine learning model. In one embodiment, the ML_squared_accuracy and other predictive performance metrics can be calculated based on the values in the confusion matrix. The sub-column “with primary predictions” of the “confusion matrix” column includes values indicating the suitability of the second machine learning model for predicting the performance of the first ML model when the second ML model uses the values predicted by the primary model as inputs generates.

In one embodiment, the analysis module 310 may calculate a suitability score based on one or more of the metrics shown in Table 1, and may compare the suitability score to a threshold to determine (1) whether the second machine learning model is a good fit for validating the predictive performance of the first machine learning model, and if so (2) whether the first machine learning model is a good fit for generating accurate predictions for the inference data set (in the absence of labels). In this manner, the ML management apparatus 104 can predict, in real time, the efficacy with which a trained model generates predictions for an inference data set while it is in production, instead of waiting minutes/hours/weeks/days/etc. to determine the predictive performance of the trained model, and if it determines that the trained model is not generating accurate predictions, the ML management apparatus 104 can react accordingly as described below with reference to the action module 312.

In one embodiment, the analysis module 310 may use additional data (e.g., in addition to the metrics in Table 1) to determine whether the first machine learning model is suitable for the inference data. For instance, the analysis module 310 may receive or access data deviation information (e.g., as described in U.S. patent application Ser. No. 16/001,904, which is incorporated by reference herein in its entirety) to determine whether and how much the inference data differs from the training data used to train the first machine learning model. If the data deviation scores do not deviate beyond a predefined threshold, then the second machine learning model may be used to determine the predictive performance of the first machine learning model on the inference data because the first machine learning model has been deemed preliminary suitable for the inference data set (e.g., in view of the data deviation scores indicating that the training data set and the inference data set are sufficiently similar or complementary). Otherwise, if the data deviation scores indicate that the inference data set is not similar enough to the training data set, so that the first machine learning model would likely not generate accurate predictions for the inference data set, the analysis module 310 may trigger one or more of the actions described below.

In one embodiment, the action module 312 is configured to trigger a remedial action associated with the first or second machine learning model, dynamically in real time, in response to the predicted suitability of the first machine learning model for analyzing the inference data set not satisfying a predetermined suitability threshold. In one embodiment, the action comprises retraining the first machine learning model using the first machine learning algorithm and a different training data set. For instance, the action module 312 may select or trigger selection of a different training data set for retraining the first machine learning model.

In some embodiments, the action comprises switching the first machine learning model to a different machine learning model trained on different training data using the first machine learning algorithm. For instance, the action module 312 may select or trigger selection of a machine learning model that has been trained on different training data, which may be more suitable or similar to the inference data set.

In one embodiment, the action comprises recommending one or more different first machine learning algorithms for analyzing the inference data set. For instance, the action module 312 may generate a notification, message, or the like that includes a recommendation for a different machine learning algorithm that may be more suitable for the inference data set based on the characteristics or the inference data set.

In various embodiments, the action comprises updating one or more thresholds associated with determining the suitability of the first machine learning model for analyzing the inference data set. For instance, the action module 312 may update or trigger updating of suitability thresholds, e.g., the thresholds used to determine whether the values generated by the second ML model indicate that the first machine learning model is suitable or unsuitable for the inference data set, to be more flexible or stringent. For example, if various first machine learning models have been generated, but none of the first machine learning models have a suitability score that satisfies the predefined threshold, then the threshold may be set too high, and the action module 312 may adjust the threshold until at least one of the first machine learning models is deemed suitable. More generally, if the suitability threshold consistently indicates that the first ML model is unsuitable for the inference data set when the performance of the first ML model is, in fact, suitable, the action module 312 may decrease the suitability threshold. Likewise, if the suitability threshold consistently indicates that the first ML model is suitable for the inference data set when the performance of the first ML model is, in fact, unsuitable, the action module 312 may increase the suitability threshold.

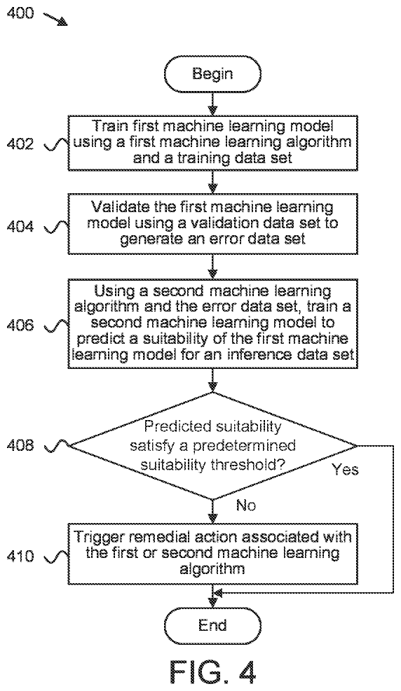

FIG. 4 is a schematic flow chart diagram illustrating one embodiment of a method 400 for determining suitability of machine learning models for datasets. In one embodiment, the method 400 begins, and the primary training module 302 trains 402 a first machine learning model using a first machine learning algorithm and a training data set. In some embodiments, the primary validation module 304 validates 404 the first machine learning model using a validation data set. The output of the validation of the first machine learning model (e.g., data generated during the process of validating the first ML model) may be stored in an error data set.

In some embodiments, the secondary training module 306 trains 406 a second machine learning model using a second machine learning model and the error data set. The second machine learning model may be configured to predict a suitability of the first machine learning model for analyzing an inference data set. In various embodiments, the analysis module 310 determines 408 whether the predicted suitability of the first machine learning model satisfies a predetermined suitability threshold. If so, the method 400 ends. Otherwise, the action module 312 triggers 410 a remedial action associated with the first or second machine learning model, and the method 400 ends.

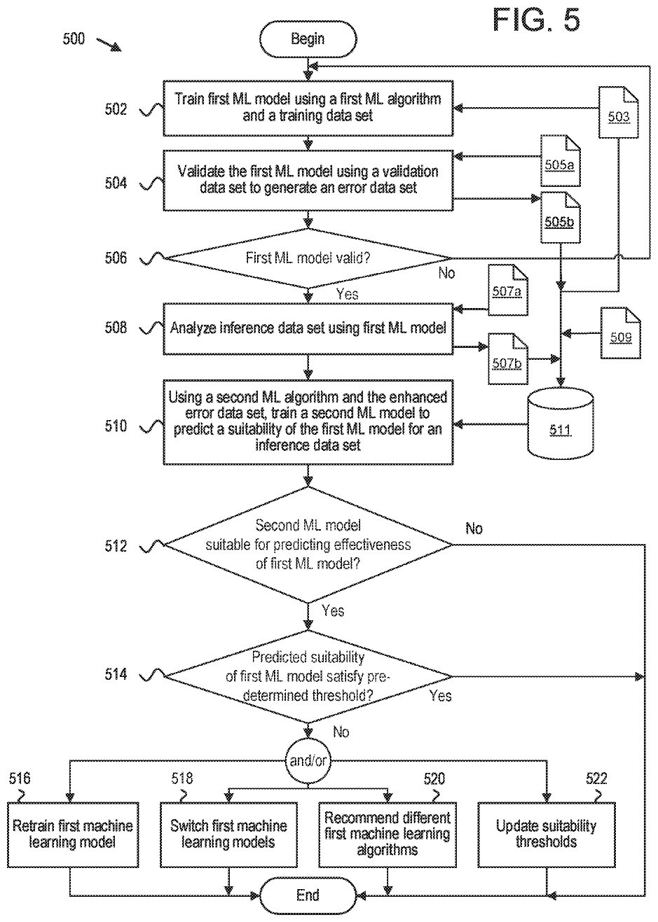

FIG. 5 is a schematic flow chart diagram illustrating another embodiment of a method 500 for determining the suitability of machine learning models for inference datasets. In one embodiment, the method 500 begins, and the primary training module 302 trains 502 a first machine learning model using a first machine learning algorithm and a training data set 503. In some embodiments, the primary validation module 304 validates 504 the first machine learning model using a validation data set 505a. The output 505b of the validation of the first machine learning model may be stored in an error data set.

In some embodiments, if the primary validation module 304 determines 506 that the first machine learning model is not a valid model, then the primary training module 302 may train 502 the machine learning model using a different training data set 503. Otherwise, the first machine learning model is used to analyze 508 an inference data set 507a to generate one or more predictions 507b for the inference data set. In certain embodiments, the training data set 503 that is used to train the first machine learning model, the validation data set 505a, the error data set 505b, the inference data set 507a, the generated one or more predictions 507b, and/or other statistical data 509 (e.g., confidence values, data deviation values, AB testing values, canary values, other health scores, and/or the like) may be combined to generate an enhanced error data set 511 that is used to train the second machine learning model.

In one embodiment, the secondary training module 306 trains 510 a second machine learning model using a second machine learning algorithm and at least a portion of the enhanced error data set 511. The second machine learning model may be configured to predict a suitability of the first machine learning model for analyzing an inference data set. In one embodiment, the secondary validation module 308 determines 512 whether the second machine learning model is suitable for assessing the predictive performance of the first machine learning model for the inference data set. If not, the method 500 ends.

Otherwise, the analysis module 310 determines 514 whether the predicted suitability of the first machine learning model satisfies a predetermined suitability threshold. If so, the method 500 ends. Otherwise, the action module 312 triggers one or more remedial actions associated with the first or second machine learning model. For instance, the action module 312 may trigger retraining 516 the first machine learning model with different training data, may trigger switching 518 the first machine learning model to a different machine learning model that is trained using different training data, may recommend 520 different machine learning algorithms for analyzing the inference data set, may update 522 suitability thresholds associated with the second ML model, and/or the like, and the method 500 ends.

Some embodiments of an error data set (or enhanced error data set) used to train a second machine learning model to predict the suitability of a first ML model for analyzing an inference data set have been described. In some embodiments, the error data set (or enhanced error data set) includes output generated during validation of the first ML model; a rate, score, or other value indicating how often the first ML model generates an accurate prediction for the validation data set; labels indicating whether the first ML model generated accurate or inaccurate predictions for one or more (e.g., all) samples in the validation data set; samples of the validation data set, including one or more (e.g., all) feature values of such samples; statistical signatures of one or more (e.g., all) samples of the validation data set; prediction values generated by the first ML model for one or more (e.g., all) corresponding samples of the validation data set; confidence metrics associated with the prediction values generated by the first ML model; parameter values associated with the first ML model; training data set used to train the first ML model; and/or data deviation values, AB testing values, canary values, other health scores, etc.

Some examples of remedial actions have been described. In some embodiments, suitable remedial actions may include reverting from the first ML model to a “known good” model (e.g., the last known good model), reverting from the first ML model to a previous model, replacing the first ML model with a recently approved ML model, and/or shutting down the predictive pipeline.

Means for training a first machine learning model using a first machine learning algorithm and a training data set may include, in various embodiments, one or more of an ML management apparatus 104, a primary training module 302, a device driver, a controller executing on a host computing device, a processor, an FPGA, an ASIC, other logic hardware, and/or other executable code stored on a computer-readable storage medium. Other embodiments may include similar or equivalent means for training a first machine learning model using a first machine learning algorithm and a training data set.

Means for validating the first machine learning model using a validation data set may include, in various embodiments, one or more of an ML management apparatus 104, a primary validation module 304, a device driver, a controller executing on a host computing device, a processor, an FPGA, an ASIC, other logic hardware, and/or other executable code stored on a computer-readable storage medium. Other embodiments may include similar or equivalent means for validating the first machine learning model using a validation data set.

Means for training a second machine learning model using a second machine learning model and the error data set include, in various embodiments, one or more of an ML management apparatus 104, a secondary training module 306, a device driver, a controller executing on a host computing device, a processor, an FPGA, an ASIC, other logic hardware, and/or other executable code stored on a computer-readable storage medium. Other embodiments may include similar or equivalent means for training a second machine learning model using a second machine learning model and the error data set.

Means for validating the second machine learning model may include, in various embodiments, one or more of an ML management apparatus 104, a secondary validation module 308, a device driver, a controller executing on a host computing device, a processor, an FPGA, an ASIC, other logic hardware, and/or other executable code stored on a computer-readable storage medium. Other embodiments may include similar or equivalent means for validating a second machine learning model.

Means for determining whether the first machine learning model is suitable for generating predictions for the inference data set based on the predictions that the second machine learning model generates may include, in various embodiments, one or more of an ML management apparatus 104, an analysis module 310 a device driver, a controller executing on a host computing device, a processor, an FPGA, an ASIC, other logic hardware, and/or other executable code stored on a computer-readable storage medium. Other embodiments may include similar or equivalent means for determining whether the first machine learning model is suitable for generating predictions for the inference data set.

Means for triggering a remedial action associated with the first or second machine learning model may include, in various embodiments, one or more of an ML management apparatus 104, an action module 312, a device driver, a controller executing on a host computing device, a processor, an FPGA, an ASIC, other logic hardware, and/or other executable code stored on a computer-readable storage medium. Other embodiments may include similar or equivalent means for triggering a remedial action associated with the first or second machine learning model.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The phrasing and terminology used herein are for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The terms “including,” “comprising,” “having,” “containing,” “involving,” and variations thereof mean “including but not limited to” unless expressly specified otherwise. An enumerated listing of items does not imply that any or all of the items are mutually exclusive and/or mutually inclusive, unless expressly specified otherwise.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A system, comprising:
a data processing system comprising memory and one or more processors to:
train, using machine learning and with input that includes a training data set having one or more labels and one or more features, a first model to perform predictions on inference data based on the labels;
generate, by the first model and with input that includes a validation data set having one or more of the labels and one or more of the features each associated with values distinct from values of the training data set, an error data set that corresponds to the first model and includes an error value that indicates an error in the error data set;
train, using machine learning and with input including the error data set, a second model that indicates a first suitability of the first model to analyze an inference data set;
generate, based on the second model, a second suitability of the second model to determine the first suitability of the first model;
generate, by the second model in response to a determination that the second suitability satisfies a first suitability threshold, the first suitability; and
trigger, in response to a determination that the second model indicates that the first suitability does not satisfy a second suitability threshold, an action that corresponds to one or more of the suitability threshold and the first model and the second model.

2. The system of claim 1, the data processing system to:
retrain, using machine learning and with input that includes a second training data set having one or more labels and one or more features and distinct from the training data set, the first model to perform predictions on inference data based on the labels.

3. The system of claim 1, the data processing system to:
switch from the first model to a third model to perform predictions on inference data based on the labels, the third model trained using machine learning and with input that includes the training data set.

4. The system of claim 3, the third model having a third suitability to analyze the inference data set that satisfies the second suitability threshold.

5. The system of claim 4, the second model having a fourth suitability to determine the third suitability of the third model that satisfies the first suitability threshold.

6. The system of claim 1, the data processing system to:
generate an indication that identifies a third model to perform predictions on inference data based on the labels, the third model trained using machine learning and with input that includes the training data set.

7. The system of claim 6, the third model having a third suitability to analyze the inference data set that satisfies the second suitability threshold.

8. The system of claim 7, the second model having a fourth suitability to determine the third suitability of the third model that satisfies the first suitability threshold.

9. The system of claim 1, the data processing system to:
modify, in response to the determination that the second model indicates that the first suitability does not satisfy the second suitability threshold, one or more of first suitability threshold and the second suitability threshold.

10. A method, comprising:
training, using machine learning and with input including a training data set having one or more labels and one or more features, a first model to perform predictions on inference data based on the labels;
generating, by the first model and with input including a validation data set having one or more of the labels and one or more of the features each associated with values distinct from values of the training data set, an error data set corresponding to the first model and including an error value that indicates an error in the error data set;
training, using machine learning and with input including the error data set, a second model including a first suitability of the first model to analyze an inference data set;
generating, based on the second model, a second suitability of the second model to determine the first suitability of the first model;
generating, by the second model in response to determining that the second suitability satisfies a first suitability threshold, the first suitability; and
triggering, in response to the determining that the second model indicates that the first suitability does not satisfy a second suitability threshold, an action that corresponds to one or more of the suitability threshold and the first model and the second model.

11. The method of claim 10, comprising:
retraining, using machine learning and with input including a second training data set having one or more labels and one or more features and distinct from the training data set, the first model to perform predictions on inference data based on the labels.

12. The method of claim 10, comprising:
switching from the first model to a third model to perform predictions on inference data based on the labels, the third model trained using machine learning and with input including the training data set.

13. The method of claim 12, the third model having a third suitability to analyze the inference data set satisfying the second suitability threshold.

14. The method of claim 13, the second model having a fourth suitability to determine the third suitability of the third model satisfying the first suitability threshold.

15. The method of claim 10, comprising:
generate an indication that identifies a third model to perform predictions on inference data based on the labels, the third model trained using machine learning and with input including the training data set.

16. The method of claim 15, the third model having a third suitability to analyze the inference data set satisfying the second suitability threshold.

17. The method of claim 16, the second model having a fourth suitability to determine the third suitability of the third model satisfying the first suitability threshold.

18. The method of claim 10, comprising:
modify, in response to the determining that the second model indicates that the first suitability does not satisfy the second suitability threshold, one or more of first suitability threshold and the second suitability threshold.

19. A computer readable medium including one or more instructions stored thereon and executable by a processor to:
train, by the processor using machine learning and with input that includes a training data set having one or more labels and one or more features, a first model to perform predictions on inference data based on the labels;
generate, by the processor and via the first model with input that includes a validation data set having one or more of the labels and one or more of the features each associated with values distinct from values of the training data set, an error data set that corresponds to the first model and includes an error value that indicates an error in the error data set;
train, using machine learning and with input including the error data set, a second model that indicates a first suitability of the first model to analyze an inference data set;
generate, by the processor and based on the second model, a second suitability of the second model to determine the first suitability of the first model;
generate, by the processor and via the second model in response to a determination that the second suitability satisfies a first suitability threshold, the first suitability; and
trigger, by the processor and in response to a determination that the second model indicates that the first suitability does not satisfy a second suitability threshold, an action that corresponds to one or more of the suitability threshold and the first model and the second model.

20. The computer readable medium of claim 19, wherein the computer readable medium further includes one or more instructions executable by the processor to:
switch from the first model to a third model to perform predictions on inference data based on the labels, the third model trained using machine learning and with input that includes the training data set.
